(19) United States
(12) Patent Application Publication
(10) Pub. No.: US 2005/0224170 A1
(43) Pub. Date: Oct. 13, 2005

(54) Method and system for making filters

(75) Inventors: Robert Wayne Shearin, Henderson, NC (US); Joyce Bullock Strother, Louisburg, NC (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Clarcor Air Filtration Products, Henderson, NC (US)

(21) Appl. No.: 10/821,343

(22) Filed: Apr. 9, 2004

(51) Int. Cl. B32B 31/00

(52) U.S. Cl. 156/293; 156/309.6

(57) ABSTRACT

A process and system is provided for manufacturing filters that has a filter medium bonded to a filter frame. A frame stock that has a hot-melt bonding material previously applied along its edge is formed into a frame and put around a filter medium. The partially assembled filter assembly is placed on a carrier that transports the filter assembly to a heating press, where heated top and bottom dies press on the frame to transfer heat to the frame to melt the hot-melt bonding material in the frame. The heated frame assembly is then transferred by the carrier into a cold sealing press, where upper and lower cooling dies engage the frame under pressure to cool the hot-melt bonding material to bond the filter medium edges to the frame.

### FIELD OF THE INVENTION

This invention pertains generally to filters, and more particularly to a method and system for making filters, such as air filters, that have a filter medium bonded to a filter frame.

### BACKGROUND OF THE INVENTION

Air filters are commonly used in home, commercial, industrial, and institutional applications for removing dust particles and debris from the air. Depending on their intended applications, air filters come in various sizes and use different filter media. Many air filters, however, share a common construction that includes a filter frame made of folded cardboard-like sheet material and a rectangular filter medium that is bonded to the frame by a bonding material.

In a manufacturing setup that existed prior to the present invention, hot presses arranged as rotating carousel stations are used to heat partially assembled filters to bond the filter frames with the filter media. In that setup, a polyolefin compound is used as the bonding material. The bonding material is pre-applied to the outer edges of a frame stock piece. During the manufacturing process, the frame stock is folded along longitudinal lines to form frame sections with a C-shaped channel. The frame sections are then wrapped around the edges of the filter medium to form a partially assembled filter assembly. The filter assembly is placed in a hot press to melt the polyolefin compound in the frame to attach the edges of the filter medium to the frame. This conventional manufacturing setup is not satisfactory for multiple reasons. It requires an operator to load the filter assembly by hand directly into the hot press, and this operation causes certain safety concerns. Moreover, a long dwell time between 11 to 14 seconds is required for the filter assembly to stay in the hot press to ensure that the polyolefin compound is melted to properly bond the filter medium and the frame together. The long dwell time significantly limits the output capacity of the manufacturing line. The existing manufacturing line also lacks production flexibility in that it requires a long maintenance time for changing the dies of the hot presses for making filters of different sizes. Accordingly, there has been a need for a new and improved manufacturing process for air filters or the like that provides improved safety, flexibility, and greater output capacity.

### BRIEF SUMMARY OF THE INVENTION

In view of the foregoing, the present invention provides a new process and system for manufacturing filters, such as air filters, that provides greater operational safety, flexibility, and significantly higher throughput. In accordance with the invention, a frame stock that has a hot-melt bonding material pre-applied along its edge is formed into a frame and applied around a filter medium to form a partially assembled filter assembly. The filter assembly is then placed on a carrier that transfers the filter assembly to a heating press station. The heating press has heated upper and lower dies that are moved to a sealing position to press on the frame for a pre-selected dwell time to transfer heat to the frame to melt the hot-melt bonding material therein. The heated filter assembly is then transferred by the carrier into a cold sealing press station that has upper and lower cooling dies that are chilled to provide efficient heat removal. The cold sealing dies are moved in to a sealing position to engage the frame of the filter assembly under pressure for a preset time to cool the hot-melt bonding material in the frame to form an effective bond between the filter medium and the frame, thereby turning the filter assembly into a finished filter. The finished filter is then transferred by the carrier to an ejection station, where the finished filter is removed from the carrier.

Additional features and advantages of the invention will be apparent from the following detailed description of illustrative embodiments which proceeds with reference to the accompanying figures.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a simplified perspective view of an exemplary filter that may be formed with the manufacturing process of the present invention;

FIG. 2 is a front view of a frame stock in the form of an elongated strip of sheet material;

FIG. 3 is a cross sectional view of the frame stock being formed into a C-shaped channel;

FIG. 4 is a simplified perspective view of a filter frame being placed around a filter medium to form a partially assembled filter assembly;

FIG. 5 is a cross sectional view of a frame segment of the filter assembly;

FIG. 6 is a simplified top view of a transport plate which has an opening for receiving a filter assembly for processing by downstream heating and cold seal press stations;

FIG. 7 is a schematic diagram showing stations of a filter manufacturing line in an embodiment of the invention; and

FIG. 8 is a flow chart summarizing a process of an embodiment of the invention for making air filters.

### DETAILED DESCRIPTION OF THE INVENTION

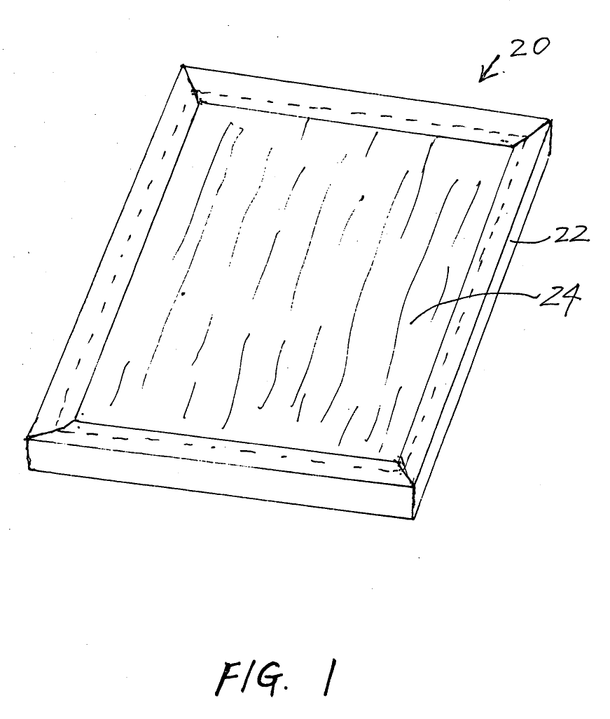

Turning now to the drawings, in which like numbers are used to refer to similar elements, FIG. 1 shows an exemplary filter 20 that has a filter construction common to filters manufactured in accordance with the invention. The filter 20 includes a frame 22 and a filter medium 24. The frame 22 servers the function of supporting and protecting the filter medium 24. As described in greater detail below, the edges of the filter medium are bonded to the inner sides of the frame. The filter medium 24 may be one of many different types of filter materials, depending on the rating and applications of the filter, and may be treated for enhanced particulate capture and retention properties. The exemplary filter 20 in FIG. 1 has a rectangular frame and a rectangular filter medium, although filters of other shapes and sizes may be formed with the process of the invention. Also, although the construction of the filter 20 is commonly found in air filters, it may be used in other types of filters.

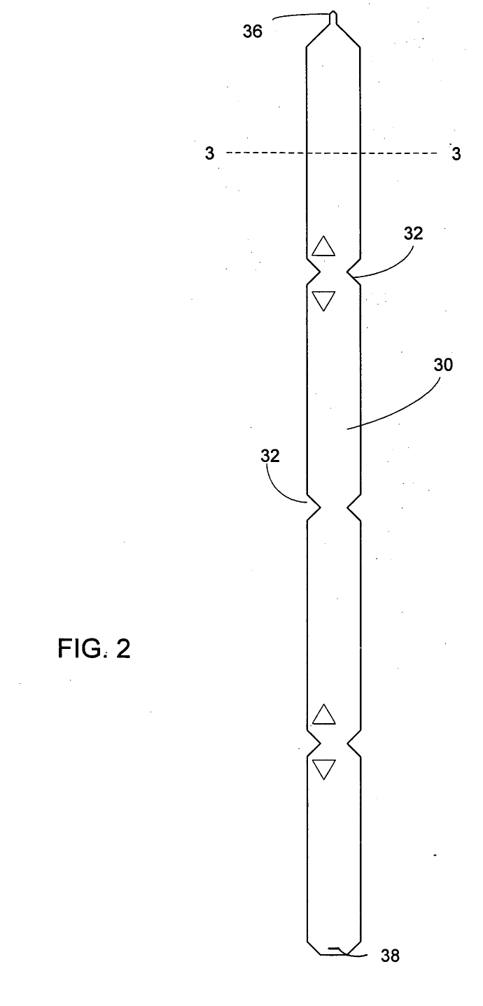

In a preferred embodiment, the frame 22 of the filter 20 is formed from a frame stock, which is typically an elongated strip of sheet material, such as cardboard or the like. As shown in FIG. 2, the frame stock 30 has notches 32 cut therein. The notches 32 are the places where the frame stock will be bent to form segments or sections of a filter frame. The filter stock 30 has a tab 36 at one end and a slit 38 at the other end. The tab 36 is configured for insertion into the slit 38 to link the end sections of the frame 22 together after the frame is applied around the filter medium 24 during the manufacturing process to form a partially assembled filter assembly as described below.

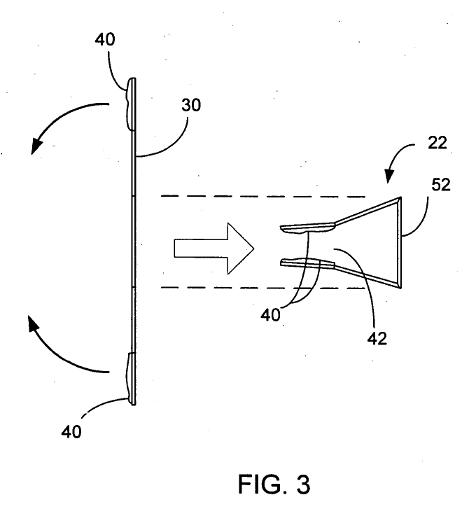

As show in the cross section view of FIG. 3, the frame stock 30 has a hot-melt bonding material 40 pre-applied along its longitudinal edges. As will be described in greater detail below, the hot-melt bonding material is used to bond the edges of the filter medium 24 to the frame 22. To convert the frame stock 30 into a frame, the frame stock is first roll-formed or folded along longitudinal lines of the frame stock to form a C-shaped channel 42, as illustrated in FIG. 3. To that end, the longitudinal fold lines on the frame stock 30 may be scored previously to facilitate the folding of the frame stock into the C-shaped channel. Each segment of the frame stock as divided by the notches 32 becomes a section of the frame. When the frame stock 30 is folded to form the longitudinal C-shaped channel 42, the pre-applied hot-melt bonding material 40 is on the inside surface of the channel near the inner edge of the frame section.

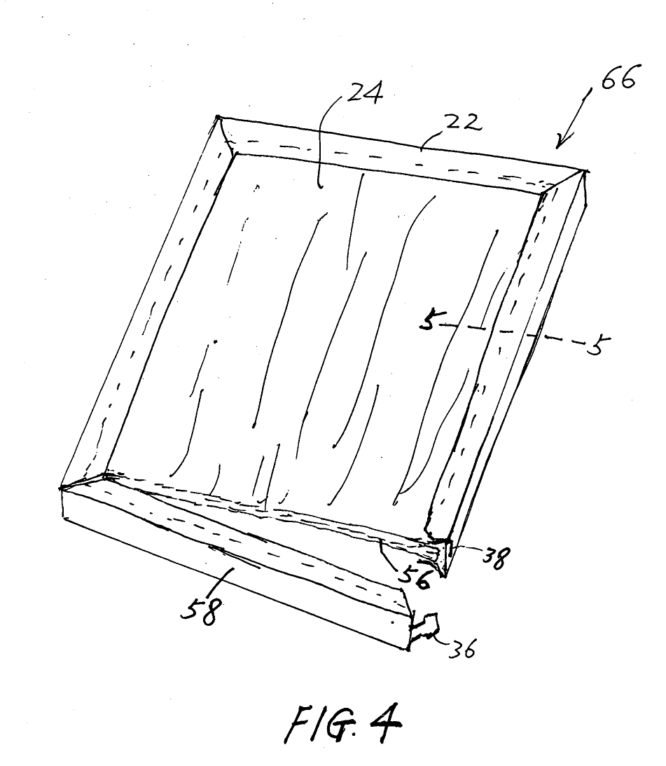

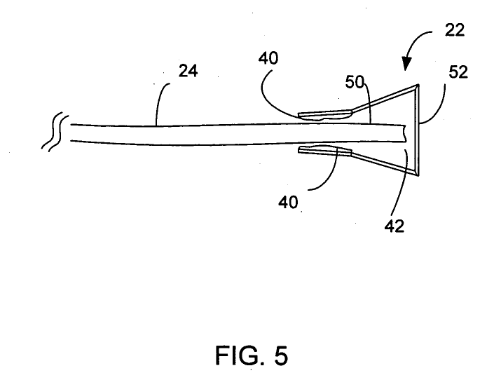

Turning to FIG. 4, after the filter stock is roll formed to form the C-shaped channels of the frame sections, the frame 22 is applied to the filter medium 24. This entails inserting the edge of each side of the rectangular filter medium 24 into the C-shaped channel 42 of a corresponding segment of the frame 22. As illustrated in FIG. 5, the edge 50 of the filter medium 24 is inserted into C-shaped channel 42 of the frame segment 52. In that position, the edge 50 of the filter medium 24 is facing the hot-melt bonding material 40 on the inside surfaces of the channel of the frame segment. FIG. 4 shows the filter medium 24 with three side edges inserted into the frame 22, with the fourth side edge 56 yet to be put into the frame section 58. When all the side edges of the filter medium 24 are inserted into the corresponding sections of the frame 22, the frame 22 is kept in the closed position by inserting the tab 36 into the corresponding slit 38 in the frame section 52. In one embodiment, an operator (a person) carries out the operation of wrapping the frame 22 around the filter medium 24 and closing the frame by inserting the end tab into the corresponding slit. In alternative embodiments, this operation may be performed an automated mechanical device. At this point, the filter medium 24 is only loosely held in the frame 22, as the side edges of the filter medium are not yet bonded to the frame sections. To distinguish this partially assembled combination from the fully assembled filter for description purposes, this partially assembled combination is herein referred to as a “filter assembly.”

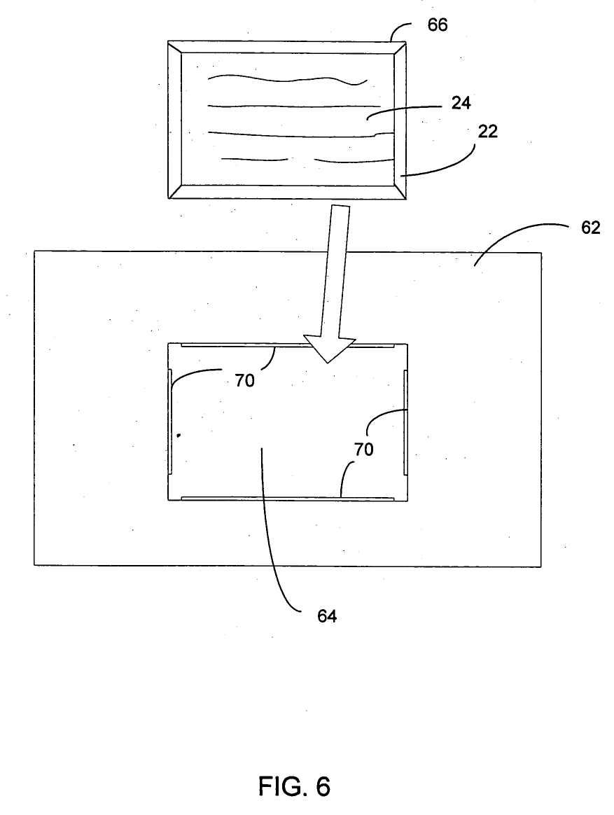

After the filter assembly is formed, it is put on a carrier to mechanically transfer it to subsequent press stations to bond the edges of the filter medium 24 with the frame 22. In one embodiment as shown in FIG. 6, the carrier includes a transport plate 62 that has an opening 64 cut therein. The opening 64 is sized for receiving the filter assembly 66. To prevent the filter assembly 66 from falling through the opening 64, narrow holding tabs 70 or ledges are provided at the bottom side of the transport plate 62. The holding tabs 70 protrude inwardly from the edges of the opening 64 such that when the filter assembly 66 is fitted into the opening the frame 22 rests on the holding tabs and thus cannot go through the opening.

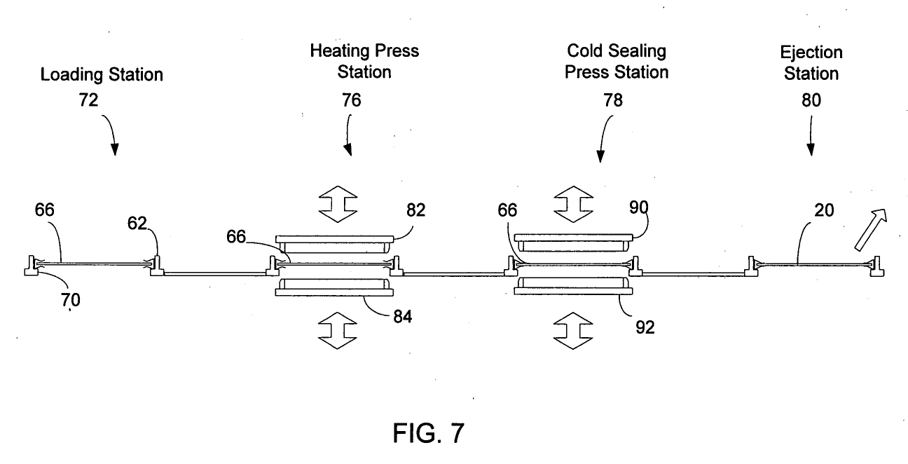

In a preferred embodiment of the invention, the manufacturing line includes four stations: a loading station 72, a heating press station 76, a cold sealing press station 78, and an ejection station 80. In accordance with an aspect of the invention, two press stages are used to process the frame assembly 66 to bond the filter frame 22 to the filter medium 24. As illustrated in FIG. 7, the first press stage is the heating press 80 that is for transmitting heat to the frame 22 of the filter assembly 66 to heat up the hot-melt bonding material therein so that the bonding material is melted. The melting activates the hot-melt bonding material to function as an adhesive. As used herein for purposes of describing the invention, “melted” or “melting” is used broadly to mean that the bonding material is either liquefied or put in a tacky state. The second press stage is the cold sealing press for cooling the frame and the melted bonding material therein. As a result of the cooling, the bonding material is hardened to bond the frame and the filter medium together.

In one embodiment as shown in FIG. 7, the hot press 76 has an upper press die 82 and a lower press die 84. Both the upper and lower dies 82 and 86 are heated and movable to a closed position for engaging the frame 22 of a filter assembly 66. When a filter assembly 66 is carried by a transport plate 62 to the heating press station, the upper and lower heated dies 82 and 84 are moved in toward the plane of the filter assembly to engage and press on the frame 22 of the filter assembly. As shown in FIG. 7, the dies 82 and 84 are sized and shaped such they stay clear of the holding tabs 70 of the transport plate while pressing on the frame 22. In one implementation, the dies are pre-heated up to about 550 degrees Fahrenheit, and then moved in toward the filter sealing plane to apply up to 125 psig of pressure to the frame while transferring heat to the frame.

In accordance with a feature of the embodiment, the dwell time required for the heated dies to engage the frame to melt the bonding material is significantly reduced by the use of a hot-melt bonding material. The hot-melt bonding material may be, for example, the hot-melt adhesive available from Sonoco Products Company in Hartsville, S.C., as part number 6E501-13. The 6E501-13 adhesive is an Ethylene Vinyl Acetate (EVA) based hot-melt material. Under the proper pressure and temperature of the heated dies 82, 84, the hot-melt bonding material in the frame can be melted quickly. The dwell time for the heated dies to press on the frame of the filter assembly for heating thereof is preferably between 0.5 and 5 seconds. In one implementation, the dwell time for heating is set to be 3 seconds. This is significantly shorter than the 15 seconds or so required in the old manufacturing setup that used polyolefin as the heating compound. The short heating time coupled with the streamlined heating and cold sealing press operations allows the manufacturing setup of FIG. 7 to have a significantly higher output rate than the conventional setup.

After the filter assembly is heated in the heating press 76 for a pre-selected dwell time such as 3 seconds, the upper and lower heated dies are retracted, and the transport plate 62 carries the heated frame to the downstream cold sealing press station 78. As shown in FIG. 7, the cold sealing press 78 has an upper cooing die 90 and a lower cooling die 92. The upper and lower cooling dies 90 and 92 are maintained at a temperature substantially lower than the melting point of the hot-melt bonding material. Once the filter assembly 66 is carried by the transport plate 62 into a proper operating position, the upper and lower cooling dies 90, 92 are moved in toward the filter assembly 66 so that they engage the heated frame 22 at a preset pressure, such as up to 125 psig, to cool the hot-melt bonding material in the frame so that the bonding material hardens and bonds the filter medium 24 to the frame 22. To enhance the efficiency of the cooling, the cooling dies are chilled to a pre-selected temperature, such as 55 degrees Fahrenheit. The chilling of the dies may be achieved by means of, for example, circulating chilled water through the dies. The frame 22 of the filter assembly 66 is cooled by the cooling dies 90, 92 under pressure for a pre-selected dwell time, preferably between 1 and 7 seconds, that is long enough to ensure that the hot-melt bonding material is fully cooled and hardened to securely bond the filter media 24 to the frame 22 to form a finished filter. The cooling dies are then retracted, and the transport plate 62 carries the finished filter 20 from the cold sealing press 78 to the ejection station 80, where the finished filter 20 is removed from the transport plate.

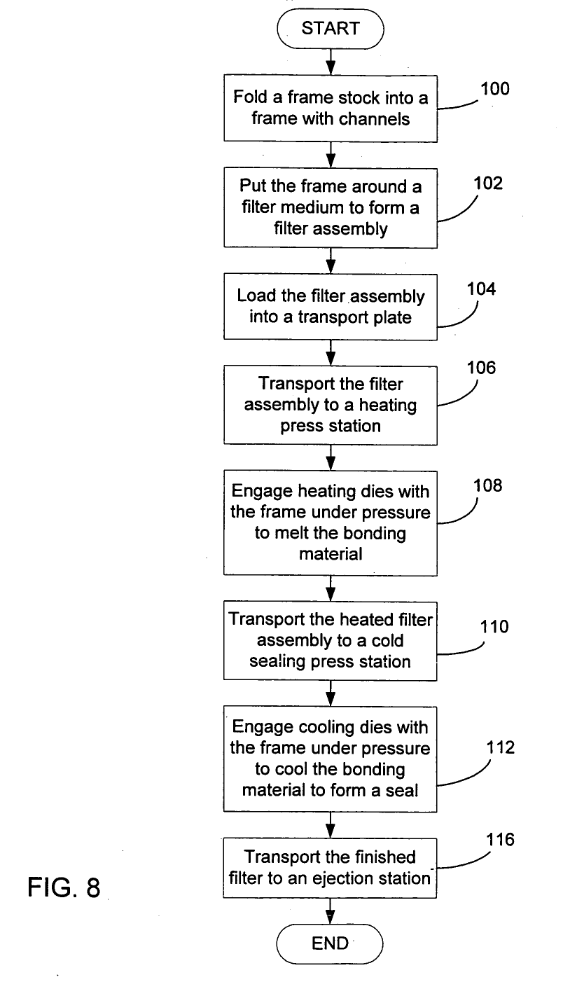

FIG. 8 summaries the process of manufacturing air filters as described above. The frame stock that has hot-melt bonding materials pre-applied thereon is formed into a frame with C-shaped channels (step 100). The frame is then wrapped and closed around a filter medium, with the side edges of the filter medium inserted into the channels of the frame, to form a filter assembly (step 102). The filter assembly is placed in the transport plate at the loading station (step 104), and the transport plate is moved mechanically to carry the filter assembly to the heating press station (step 106). The heating dies of the heating press engage the frame of the filter assembly under pressure for a preset dwell time, such as 3 seconds, to melt the hot-melt bonding material inside the channel of the frame (step 108). The transport plate carrying the heated filter assembly is then mechanically moved to the cold sealing press station (step 110). The cooling dies of the cold sealing press move in and engage the frame of the filter assembly under pressure for a preset dwell time, such as 5 seconds, to cool the hot-melt bonding material until it hardens and bonds the filter medium edges and the frame together (step 112). The transport plate then carries the finished filter to the ejection station (step 114), where the filter is removed from the transport plate (step 116).

It will be appreciated that the invention providing an improved method and system for making filters with a filter medium bonded to the filter frame by hot-melt adhesive has been disclosed herein. In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that the illustrated embodiments can be modified in arrangement and detail without departing from the spirit of the invention. Therefore, the invention as described herein contemplates all such embodiments as may come within the scope of the following claims and equivalents thereof.

1. A method of making a filter, comprising:
providing a partially assembled filter assembly having a frame and a filter medium, the filer medium having side edges inserted into a channel of the frame, the frame having pre-applied bonding material within the channel facing the side edges of the filter medium;
mechanically transferring the filter assembly into a heating press having at least one heated die;
engaging the at least one heated die with the frame of the filter assembly under pressure for a first time period for heating the frame to melt the bonding material;
mechanically transferring the filter assembly with the melted bonding material to a cold sealing press having at least one cooling die;
engaging the at least one cooling die with the frame of the filter assembly under pressure for a second time period for cooling the bonding material to bond the edges of the filer medium with the frame to form a sealed filter;
mechanically transferring the sealed filter to an ejection station for removal thereof.

2. A method as in claim 1, wherein the bonding material is a hot-melt adhesive.

3. A method as in claim 2, wherein the first time period is between 0.5 and 5 seconds.

4. A method as in claim 3, wherein the first time period is about 3 seconds.

5. A method as in claim 2, wherein the heating press has upper and lower heating dies movable to engage the frame of the filter assembly under a first pre-selected pressure.

6. A method as in claim 5, wherein the first pre-selected pressure is up to 125 psig.

7. A method as in claim 2, wherein the cold sealing press has upper and lower cooling dies movable for engaging the frame of the filter assembly under a second pre-selected pressure.

8. A method as in claim 7, wherein the second time period is between 1 and 7 seconds.

9. A method as in claim 2, wherein the hot-melt adhesive is an ethylene vinyl acetate based compound.

10. A method as in claim 1, wherein the steps of mechanically transferring employs a transport plate movable sequentially to the heating press, cold sealing press, and ejection station, the transfer plate having a support structure for receiving and supporting the filter assembly.

11. A method as in claim 10, wherein the support structure includes an opening in the transport plate sized for receiving the filter assembly, and holding tabs inwardly protruding from edges of the opening for holding the frame of the filter assembly.
